(19) United States
(12) Patent Application Publication
(10) Pub. No.: US 2010/0131588 A1
(43) Pub. Date: May 27, 2010

(54) Error processing methods to provide a user with the desired web page responsive to an error 404

(75) Inventor: OLIVER ALEXANDER LOFTUS, BUCKINGHAM (GB)

Correspondence Address: OLIVER ALEXANDER LOFTUS, 4, CATHERINE COURT, BUCKINGHAM, MK18 1UG, omitted

(73) Assignee: LINKGRAPH LIMITED, BUCKINGHAM (GB)

(21) Appl. No.: 12/324,711

(22) Filed: Nov. 26, 2008

(51) Int. Cl. G06F 15/16

(52) U.S. Cl. 709/203

(57) ABSTRACT

The present invention relates to a method of utilising the error message a web server returns to a web client when an ‘error 404’ occurs, to deliver a script embedded in the error message, which resolves the error by retrieving from an error processing server the most up-to-date correct URL of the web page the user at the web client tried to access. That error processing server itself has a database of such information due to an indexing application running on participating web servers, periodically updating said database with the most current location of web pages on that web server, each tracked with a unique number attached thereto.

### CROSS-REFERENCE TO RELATED APPLICATIONS

Not Applicable

### STATEMENT REGARDING FEDERALLY SPONSOSORED RESEARCH OF DEVELOPMENT

Not Applicable

### REFERENCE TO SEQUENCY LISTING, A TABLE, OR A COMPUTER PROGRAM LISTING COMPACT DISC APPENDIX

Not Applicable

### BACKGROUND OF THE INVENTION

1. Field of the invention

The present invention relates to a method for resolving 404 errors that occur due to broken links on websites on a computer network such as the internet, preventing a web page from being displayed.

2. Background to current situation

When a user of a website clicks a broken link, that is a hyperlink that points to a non-existant web page or other resource such a PDF/image etc. . . . , the web server to which a request was made in clicking the link returns to the web client, from which the request originated, an error 404. This error means that the desired web page identified in the requested URL (Uniform Resource Locator) could not be found on that web server, and usually contains an error message such as ‘Page not found’. This error message, that is returned to a web client in the event of an error 404, can be customised by the operator of a website just as with any other web page.

Broken links can be caused by a number of reasons, but are most commonly caused by the removal/moving/renaming of web pages without updating all links on the World Wide Web, and are increasing in number due to greater size and complexity of websites today. While it may be possible to completely remove all broken links from one's own website, it is impossible to apply this web-wide (over the entire WWW), as one does not have control over the content of other websites. For this reason, broken links are very common on the WWW and are extremely difficult to erradicate. Broken links and error 404s cause great irritation to users of websites as information cannot be found, and this in turn results in great loss of reputation for the websites involved, that is the website hosting the broken link, and the website to which the broken link points and therefore the website on which the error 404 actually occurs. The present invention seeks to solve this problem, by reducing the number of broken links on the WWW.

### BRIEF SUMMARY OF THE INVENTION

The present invention reduces the number of broken links on the WWW by using the functionality of being able to freely customise the error message one's web server returns to users in the event of an error 404, as described in the Background of the Invention, to embed into the custom error 404 a script which communicates with an error processing server, which matches the old broken URL requested by the web client sent by the script with a new correct URL, in order to direct the website visitor to the correct web page in the event of an error 404.

The error processing server contains a database which maintains a record of the history of any participating web page on any participating web server, by periodically receiving location data about that web page from an indexing application installed on that web server which tracks the locations/names (filepaths) of web pages on that server with a constant unique number. The result of the invention is a system that effectively erradicates/reduces the number of broken links pointing to a particular web site, and thereby erradicates/reduces the number of error 404s returned by that website.

It must be noted, that from a technical point of view, the number of error 404s is not reduced, as the error messages are still served; however, the error messages served with the system implemented, resolve the error, resulting in the correct web page being viewed.

### BRIEF DESCRIPTION OF SEVERAL VIEWS OF THE DRAWING

FIG. 1 shows the preferred embodiment of the invention, whereby an error 404 is resolved by the herein described system.

FIG. 2 shows a logical flowchart of the processes involved in resolving an error 404 in accordance with the preferred embodiment of the herein described system.

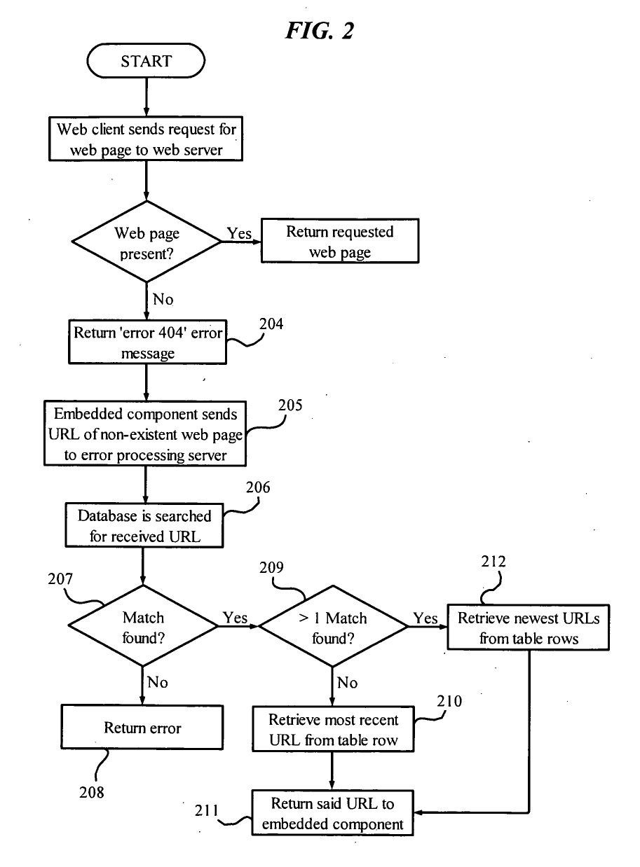

FIG. 3 shows a more detailed view of the relationship between the indexing application and the error processing server and a more detailed view of the operation of the indexing application.

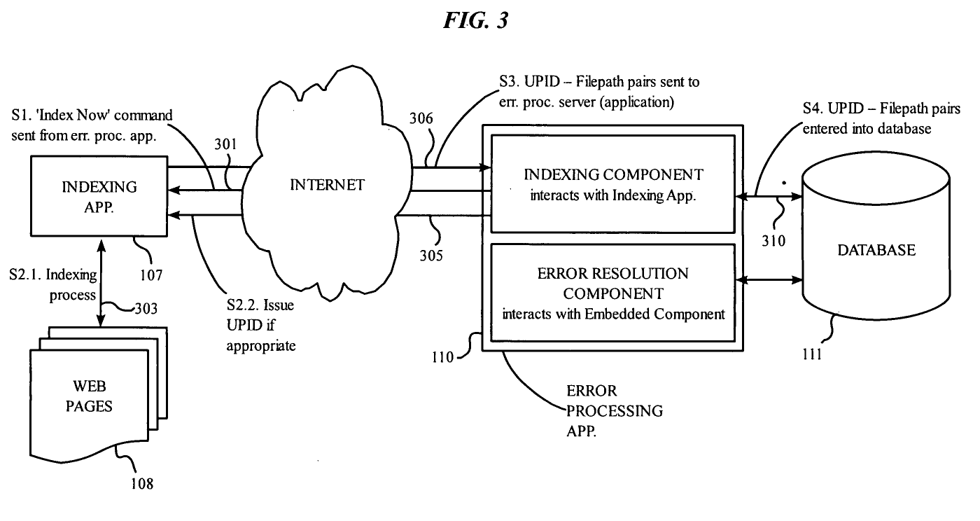

FIG. 4. shows the logical flowchart of the processes involved in the indexing application indexing web pages on a web server.

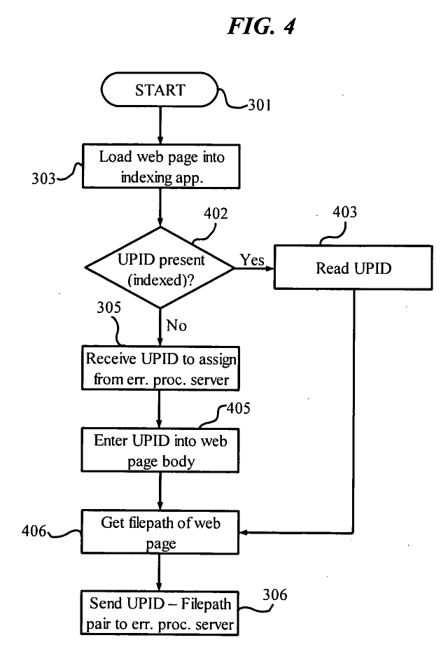

FIG. 5 shows the thoretical structure of the database tables in the database on the error processsing server containing UPID-URL entries.

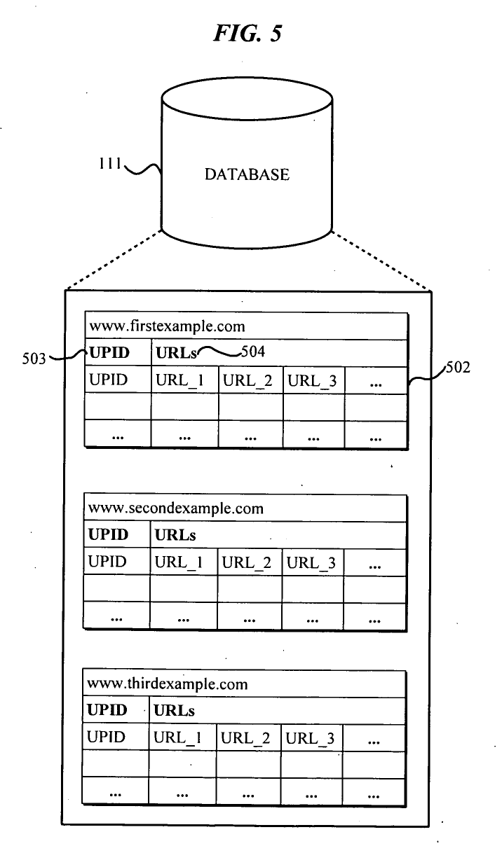

FIG. 6 shows an illustration of the component embedded in the ‘error 404’ error message that is displayed at the web client immediately when an error 404 occurs.

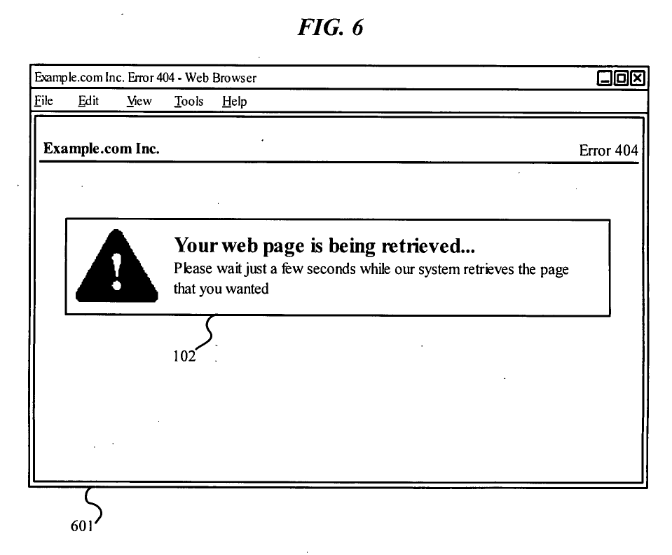

FIG. 7 shows an illustration of the embedded component as in FIG. 6, except that this view is displayed at the web client in the event of multiple possible URLs being retrieved from multiple database table rows.

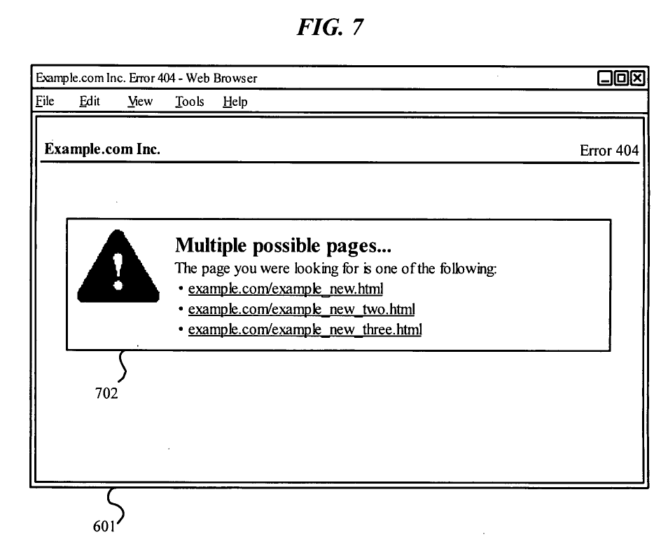

FIG. 8 shows an illustration of the embedded component as in FIG. 6, except that this view is displayed at the web client in the event of the requested web page having been deleted from the web server.

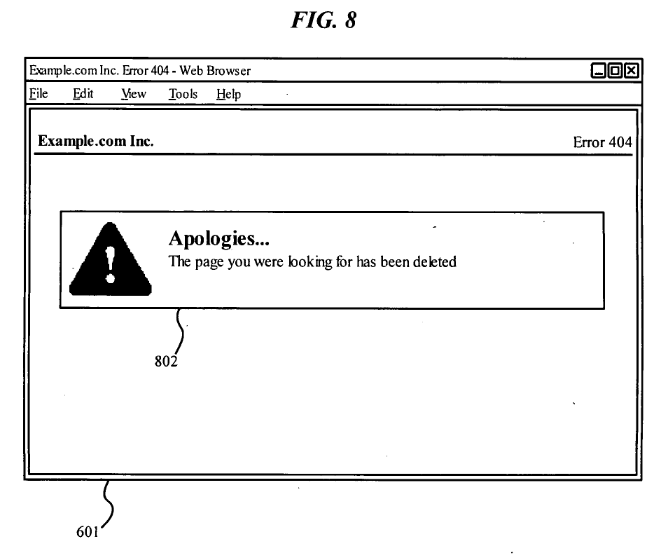

### DETAILED DESCRIPTION OF THE INVENTION

For the purpose of illustration, the herein described invention is shown as having only one web client 101 communicating with one web server 106 and the error processing server 109, and only one web server communicating with the error processing server. In reality, however, a plurality of web clients may be communicating with a plurality of web servers and the error processing server, and a plurality of web servers may be communicating with the error processing server. It is assumed that any communication by any party with the error processing server is always to the error processing application 110 hosted thereon.

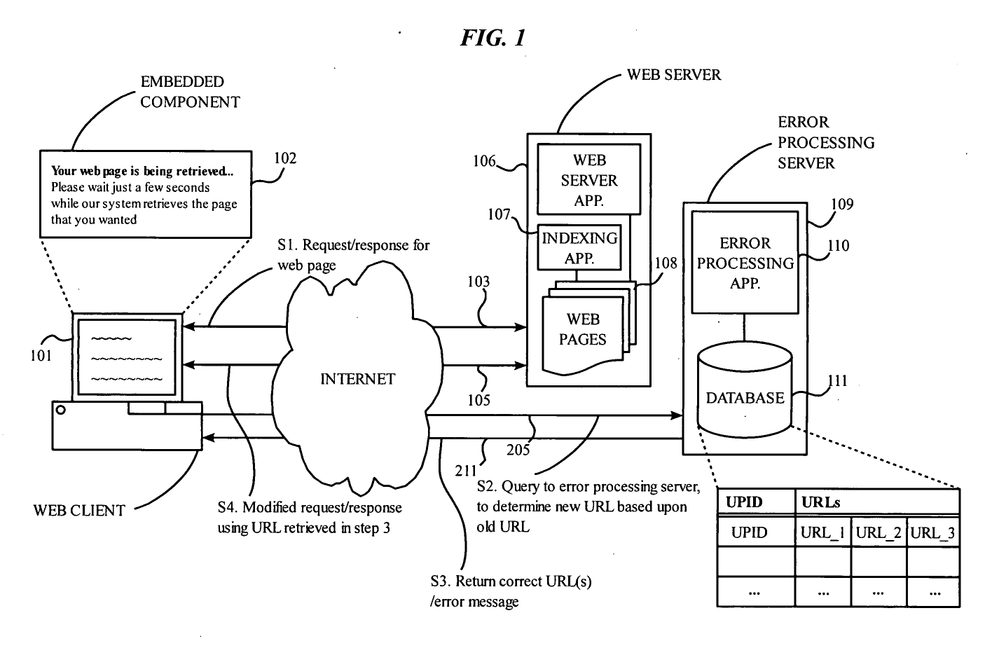

FIG. 1 describes the preferred embodiment of the present invention, wherein a web client 101, communicating with a web server 106, receives an ‘Error 404; Page not Found’ error message 204 from that web server, as a result of a request 103 made for a non-existent web page, and where this returned error message displayed in the web browser 601 at the web client contains an embedded component 102, which notifies 205 the ‘error processing server’ 109 which is running the ‘error processing application’ 110 of the URL of the web page which the web client requested that resulted in the web server sending the error message. The error processing server, upon receiving that URL from the embedded component, searches 206 the database 111 for that URL and, if and when one match is found 207, retrieves 210 from the table row in which the URL was found the most recently added URL. The error processing server then sends 211 this retrieved URL back to the embedded component. Upon receipt of this new URL from the error processing server, the embedded component which is embedded in the error 404 error message directs 105 the user at the web client to that URL.

If, however, the error processing server cannot find a match 207 in the database table 502 for the website hosted on that web server, that is, if a user at the web client has requested a non-existent web page on that web server that has not been indexed by the indexing application 107 and is therefore not present in the database table, the error processing server delivers an error message 208 to the embedded component which, in turn, may display this error message to the user at the web client. Equally, as described subsequently, if the requested non-existent web page has been deleted, and therefore the error processing server delivers an appropriate error message to the embedded component, the embedded component will in turn display an appropriate error message 802 to the user at the web client.

In the event that, at different points in time in the past, two or more web pages 108 shared the same filepath on the web server, the situation will arise where there are duplicate entries in the database table for a particular website; that is, multiple table rows in the database on the error processing server will contain an identical URL. In such an event, when more than one match is found 209 in the database table for the website hosted on that web server, that is, multiple table rows contain the same URL as received by the error processing server, the most recently added URL in each table row in which said URL was found is retrieved 212, and is sent 211 to the embedded component. Upon receipt of this plurality of potentially correct URLs from the error processing server, the embedded component displays a list of said URLs 702.

For the purpose of illustration, the error processing server is described as storing URLs 504 of web pages in the database, as opposed to filepaths of web pages. In reality, however, the database on the error processing server may store this information in this way but equally may store it differently. For example, the database may store web page information as URLs or partial URLs or filepaths or partial filepaths, or in any other such appropriate fashion, which can be transformed into URLs when required, for example, for searching 206/retrieval 210 212.

The web server contains an indexing application 107 communicating with the error processing server. This indexing application is periodically executed 301 as a result of a command issued by the error processing sever, and subsequently indexes 303 all web pages 108 specified by the web server operator. The indexing of the web server has two ‘modes’ 402: 1) indexing un-indexed web pages, and 2) indexing previously indexed web pages. When an un-indexed web page is loaded 303 into the indexing application, the application associates that web page with a unique constant number—the ‘UPID’ 503, which is specified 305 by the error processing server, by entering 405 that number into the body of the web page and sending 306 the UPID assigned to that web page, and the filepath 406 of that web page on the web server, as a corresponding pair to the error processing server. Upon receiving this <UPID-Filepath> pair from the indexing application running on the web server, the error processing server creates a new table row in the database table for the website hosted on that web server, and converts the recieved filepath to a URL, and then enters 310 the received <UPID-URL> pair.

When an indexed web page 108 is loaded 303 into the indexing application, the application reads 403 the UPID already inserted into the body of the web page, and sends 306 this UPID, and the location 406 of that web page on the web server, as a corresponding pair to the error processing server. Upon receiving this <UPID-Filepath> pair from the indexing application running on the web server, the error processing server searches the database table for the website hosted on that web server for the UPID received. When a match is found, the received filepath is converted to a URL and this URL is appended 310 to the existing list 504 of URLs in that row. This is now the most recently added URL. The result of this re-indexing of already indexed web pages is that the database residing on the error processing server is maintained with the history of every indexed web pages on that web server.

If the error processing server does not receive 306 a full <UPID-Filepath> pair listing from the indexing application for a website, that is, one or more web pages 108 that had previously been indexed could not be indexed as they were no longer found on the web server, the error processing server will note that those particular web pages have been deleted and will record this in the respective table rows in the table for that website in the database. When a user at the web client makes a request for such a web page that has been deleted, and consequently the embedded component returned in the error 404 error message sends the URL of this deleted web page to the error processing server, the database will be searched for that URL and, when found, the notice that this web page has been deleted and thus could not be indexed is retrieved. The error processing server then sends this error message that the requested web page has been deleted back to the embedded component. Upon receipt of this error message, the embedded component will in turn display an appropriate error message 802 to the user at the web client.

For the purpose of illustration, the communication 301 305 306 between the error processing server 109, and the web server 106, which is the result of the communication between the error processing application 110 and the indexing application 107, has been described as a direct connection via the Internet between the two servers. In reality, however, this connection may be made through a variety of different intermediaries such as a proxy. In such a case, however, the effect of the transaction would be the same, in that the described URL information would be exchanged between said servers.

While the present invention has been described by way of illustration for the purposes of clarity and understanding, it will be obvious to those skilled in the art, that certain modifications may be made to the system without deviating from the invention. Therefore, the scope of this invention shall be defined only by the appended claims.

What is claimed is:

1. A system comprising:
1) an indexing application hosted on a web server, wherein this application takes note of any changes to the filepath of any web pages hosted on that web server, through some tracking mechanism, and notifies an error processing server of such changes;
2) an error processing server, which maintains a database of the information collected through the indexing application hosted on the web server, and on which is also running an application capable of receiving and processing data from the embedded component in the error message returned with the error 404, and the indexing application;
3) a component embedded in the error message returned to a web client by the web server in the event of an error 404, which retrieves the URL of the web page that was requested and that caused the error 404, from the web client, and sends this URL to the error processing server, and receives and processes a subsequent response from the error processing server.

2. The system of claim 1, wherein the purpose of the system is to resolve an error 404 caused by the user at the web client requesting a non-existent resource from a web server.

3. A method of resolving an error 404 caused by a web client requesting a non-existent resource from a web server, wherein a component embedded in the error message returned by that web server to the web client retrieves the URL which was requested, and sends this URL to an error processing server, which sends back a different correct URL which points to the desired resource.

4. A method of mapping a broken URL, that once pointed to a resource on a web server, to the last known URL of that resource, wherein lists of past URLs of particular resources are stored, as well as the last known working URLs of these resources, and these lists of URLs are searched through for the particular broken URL which, when found, causes the newest URL, added to the row in which the first URL was found, to be retrieved.

5. The method of claim 4, wherein the described lists are stored in table rows, wherein each table row contains a list of past URLs, the last list item in this list being the last known working URL of one particular resource.

6. A method of indexing the web pages stored on a web server, wherein an indexing application also residing on this web server is running, and this indexing application associates a unique identifier to each participating web page on the web server so that that web page may be consistenly tracked, irrespective of its location/name on that web server.

7. The method of claim 6, wherein said indexing application assigns unique identifiers to web pages, based upon information supplied by the error processing server.

8. The method of claim 6, further comprising said indexing application inserting the assigned unique identifier into the body of the web page, and furthermore, sending this unique number assigned to the web page, and the filepath of that web page, as a corresonding pair to the error processing server.

9. The method of claim 6, wherein the error processing server to which filepaths are sent is capable of converting these filepaths to URLs to be stored in the database.

10. A method of resolving an error 404 caused by the user at the web client requesting a non-existent resource from a web server, comprising the following steps:
1) the web server to which the web client issued a request for a non-existent resource responding with an error 404 containing an embedded component;
2) said embedded component retrieving the URL that the web client requested, and sending this URL to the error processing server;
3) the error processing server using this received URL to search its database for the most recent known working URL of the web page described in the received URL and, if such a new URL is found, retrieving it from the database, and sending this retrieved URL to the embedded component;
4) the embedded component receiving this URL from the error processing server, and directing the web client to that URL.

11. The method of claim 10, wherein, if the search described in step 3 returns multiple URLs, all these URLs are sent to the embedded component.

12. The method of claim 10, wherein, if the search described in step 3 returns no URLs, an error message is sent to the embedded component.

13. The method of claim 10, wherein, if the embedded component described in step 4 receives a plurality of URLs from the error processing server, this plurality of URLs is displayed in a list.

14. The method of claim 10, wherein, if the embedded component described in step 4 receives an error message from the error processing server, this error message is displayed.

15. The method of claim 10, wherein the database described in step 3 is populated with URL information as a result of an indexing application running on a participating web server, the indexing method comprising the following steps:
1) the error processing server sending a command to the indexing application on the web server, to start indexing the web pages on that web server;
2) the indexing application receiving this command and subsequently starting to index the web pages on that web server;
2) the indexing application opening a web page to index, and determining whether the web page has already been indexed;
3) the indexing application, either receiving from the error processing server the unique number with which to associate this web page, and inserting this unique number in to the body of the web page; or
4) reading the existing unique number in the body of the web page;
5) the indexing application retrieving the filepath of the web page into which the unique number was inserted, or from which an existing unique number was read, and subsequently sending the filepath of the web page in addition to the unique number inserted/read, as a corresponding pair to the error processing server;
6) the error processing server receiving the <unique number-filepath> pair and subsequently either creating a new table row in the table for the website hosted on that web server, and converting the received filepath to a URL and then inserting the received unique number and the URL into the newly created table row; or
7) searching the database for an existing entry with the received unique number and, when found, converting the received filepath to a URL and then appending this URL to the existing list of URLs;
8) the indexing application repeating steps 2 through 7 for each web page on the web server to be indexed.

16. The method of claim 15, wherein the operator of that web server can specify which web pages on the web server are to be indexed by the indexing application.
